(19) United States
(12) Patent Application Publication
(10) Pub. No.: US 2026/0296014 A1
(43) Pub. Date: Oct. 1, 2026

(54) LIQUID EJECTION DEVICE

(71) Applicant: BROTHER KOGYO KABUSHIKI KAISHA, Nagoya (JP)

(72) Inventor: Kazuya SEKO, Nagoya (JP)

(73) Assignee: BROTHER KOGYO KABUSHIKI KAISHA, Nagoya (JP)

(21) Appl. No.: 19/578,379

(22) Filed: Mar. 25, 2026

(30) Foreign Application Priority Data
Mar. 31, 2025 (JP) 2025-059888

(51) Int. Cl. B41J 2/14; B41J 2/155

(52) U.S. Cl. CPC B41J 2/14274; B41J 2/155; B41J 2202/08

(57) ABSTRACT

A liquid ejection device includes an ejection head having a nozzle plate with a plurality of nozzles configured to eject liquid, an actuator configured to eject liquid through the nozzles, and a head drive unit configured to drive the actuator. The device further includes a substrate having a surface extending in a direction intersecting the nozzle plate, and one or more electronic components mounted on the substrate surface and configured to control the head drive unit. A cooling mechanism is provided to cool the ejection head. A supporting body is thermally coupled to and supports the ejection head. The supporting body includes a first surface facing the substrate surface in the intersecting direction, and one or more contact parts that are thermally connected to the electronic components.

### REFERENCE TO RELATED APPLICATIONS

This application claims priority from Japanese Patent Application No. 2025-059888 filed on Mar. 31, 2025. The entire content of the priority application is incorporated herein by reference.

### BACKGROUND ART

The present disclosure relates to a liquid ejection device.

A liquid ejection device is widely known.

An example of the liquid ejection device includes a head module having a nozzle plate, a circuit board, and a fixing plate that secures both the head module and the circuit board. The head module includes a cooling liquid flow path, and is cooled by cooling water flowing through the cooling liquid flow path. Further, a liquid is supplied to the head module through a plurality of flow path tubes.

### SUMMARY

In some cases, the liquid ejection device described above is used as a print engine of an inkjet printer. In such applications, heat generated by electronic components on the circuit board may raise the temperatures of the liquid (e.g., ink) and the head module, potentially causing instability in the liquid ejection. In particular, the flow path tubes that supply the liquid to the head module are located near the circuit board, making the liquid inside the tubes susceptible to heating by the electronic components. When the liquid is heated, its viscosity changes, which in turn alters the amount of ejected droplets. This change in droplet volume can result in uneven or inconsistent ink deposition, thereby degrading the quality of the printed image.

According to aspects of the present disclosure, there is provided a liquid ejection device including an ejection head having a nozzle plate with a plurality of nozzles for ejecting liquid, a plurality of actuators, and a head drive unit configured to drive the plurality of actuators to eject the liquid from the plurality of nozzles. The device also includes a substrate having a substrate surface extending in a direction intersecting the nozzle plate, one or more electronic components mounted on a substrate surface, the electronic components being configured to control the head drive unit, a cooling mechanism configured to cool the ejection head, and supporting body configured to support the ejection head. The supporting head thermally contacts the ejection head. The supporting body includes a first surface. The first surface faces the substrate surface and extends in the intersecting direction. The supporting body also includes one or more contact parts thermally contacting the electronic components.

According to the above configuration, the one or more electronic components that control the head drive unit are thermally connected to the ejection head via a supporting body that is also in thermal contact with the ejection head. The ejection head is cooled by a cooling mechanism. With this arrangement, heat generated by the electronic components can be conducted to the ejection head through the supporting body, and subsequently dissipated by the cooling mechanism. As a result, excessive heating of liquid supplied to the nozzles can be suppressed, contributing to the thermal stability of the liquid in the ejection head. This enables more stable liquid ejection performance, particularly under continuous operation or high-load driving conditions where thermal accumulation could otherwise degrade ejection accuracy or reliability.

According to aspects of the present disclosure, there is also provided a liquid ejection device. The liquid ejection device includes an ejection head including a nozzle plate having a plurality of nozzles configured to eject liquid, an actuator, and a head drive unit configured to drive the actuator to eject the liquid from the nozzles, a substrate having a substrate surface extending in a direction intersecting the nozzle plate, one or more electronic components disposed on the substrate surface, the electronic components being configured to control the head drive unit, a cooling mechanism configured to cool the ejection head, and a thermal coupling and heat-transfer structure configured to transfer heat generated by the electronic components to the ejection head, which is cooled by the cooling mechanism.

According to the above configuration, the one or more electronic components that control the head drive unit are thermally coupled to the ejection head through a thermal coupling and heat-transfer structure. Since the ejection head is cooled by the cooling mechanism, heat generated by the electronic components can be efficiently transferred to the ejection head and dissipated via the cooling mechanism. This suppresses excessive heating of the liquid supplied to the nozzles and ensures the thermal stability of the liquid within the ejection head. Consequently, the liquid ejection device can achieve stable liquid ejection performance, particularly during continuous printing or high-load operation where heat accumulation in the electronic components might otherwise impair ejection precision and reliability.

### BRIEF DESCRIPTION OF DRAWINGS

FIG. 1 is a plan view of a schematic configuration of a liquid ejection device.

FIG. 2 is a plan view showing an example of main part of a line head viewed from a nozzle surface of the liquid ejection device.

FIG. 3 is a perspective view illustrating an example of a head unit of the liquid ejection device.

FIG. 4 is a partial cross-sectional view illustrating a main part of an ejection head of the liquid ejection device.

FIG. 5 is a side view illustrating an example of the head unit of the liquid ejection device.

FIG. 6 is a side view illustrating the first surface of the head unit as viewed in a direction normal to the first surface.

FIG. 7 is a side view illustrating another example of the head unit of the liquid ejection device.

FIG. 8 is a side view illustrating still another example of the head unit of the liquid ejection device.

### DESCRIPTION

Hereinafter, embodiments of the present disclosure will be described with reference to the accompanying drawings. It is to be understood, however, that the present disclosure is not limited to the following embodiments. In the drawings, the same or corresponding elements are denoted by the same reference numerals, and redundant description thereof will be omitted.

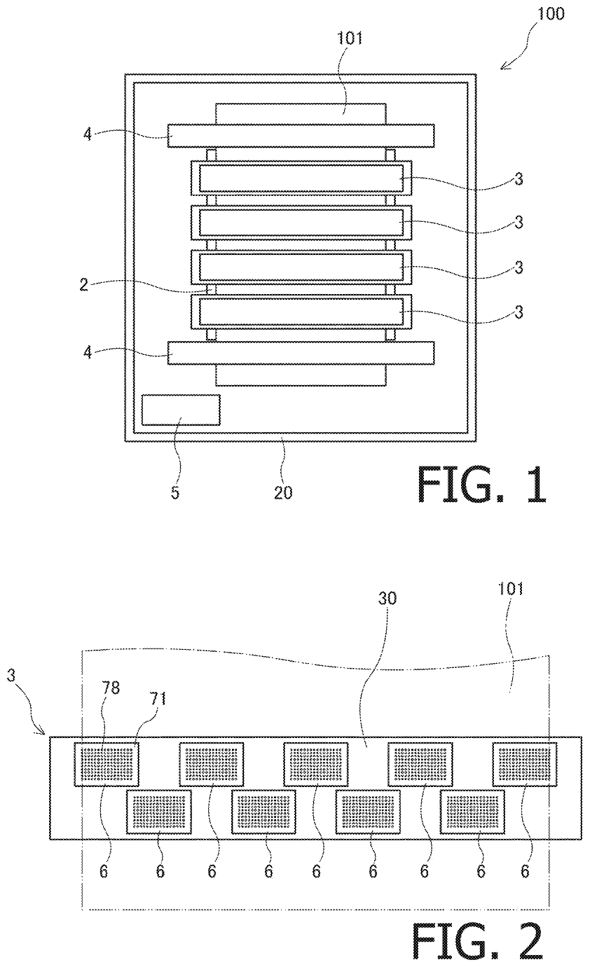

FIG. 1 is a plan view illustrating an example configuration of a liquid ejection device 100 according to a first embodiment.

The liquid ejection device 100 is a device configured to eject liquid from an ejection head 70 based on image data to form an image on a recording medium 101, such as a printing sheet. In the following description, the liquid ejection device 100 is described as an inkjet printer in which ink is used as the liquid. The liquid ejection device 100 includes a housing 20, a platen 2 disposed within the housing 20, one or more line heads 3, two rollers 4, and a controller 5. It should be noted that the number of the line heads 3 and the number of the rollers 4 are not limited to those shown in FIG. 1. In this embodiment, the liquid ejection device 100 is implemented as a line-head-type inkjet printer, in which printing is performed by ejecting ink from the line head(s) while moving the recording medium 101.

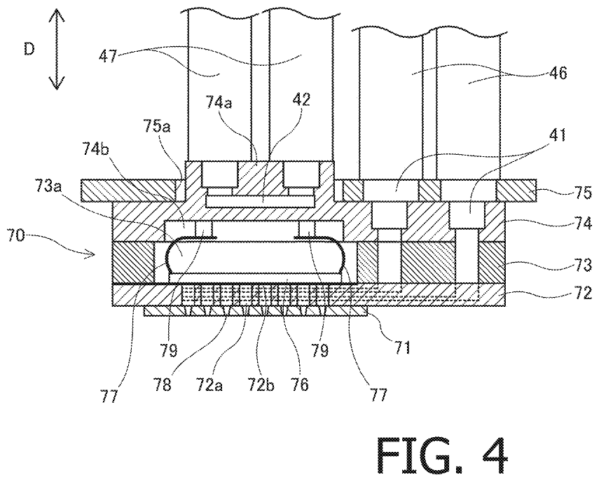

The recording medium 101 used in the liquid ejection device 100 is placed on the platen 2. The recording medium 101 may be, for example, a recording sheet such as paper. In the example shown in FIG. 4, two rollers 4 are disposed at both ends of the platen 2 in the conveying direction of the recording medium 101. The recording medium 101 is conveyed by the rollers 4 as they rotate.

In the present embodiment, the liquid ejection device 100 includes four line heads 3. These four line heads 3 respectively correspond to four colors, such as cyan, magenta, yellow, and black. Each line head 3 has a rectangular outer shape in plan view, and is disposed to face the platen 2 such that its shorter side aligns with the conveying direction of the recording medium 101 and its longer side aligns with a direction perpendicular to the conveying direction. The line heads 3 are arranged in a row between the two rollers 4 with their longer sides facing one another and spaced apart at intervals.

The controller 5 includes a control unit such as an ASIC (Application Specific Integrated Circuit) or an FPGA (Field Programmable Gate Array), and a storage unit such as a ROM (Read Only Memory), a RAM (Random Access Memory), or an EEPROM (Electrically Erasable Programmable Read-Only Memory). The controller 5 is configured to communicate with external devices, such as a personal computer. In response to instructions input from an external device or via an operation unit provided to the liquid ejection device 100, the controller 5 controls the operations of the line heads 3 and the rollers 4 in accordance with programs stored in the storage unit. It should be noted that the control unit of the controller 5 may include a CPU (Central Processing Unit) or an MPU (Microprocessor Unit) instead of, or in addition to, the ASIC or FPGA.

It should be understood that, throughout this specification and the claims, the terms “unit”, “module” and “section” are intended to refer to hardware-based components, assemblies, or structural elements, unless expressly indicated otherwise. In this context, “unit” and “module” may refer to a discrete hardware component or device comprising one or more physical elements, and “section” may refer to a defined portion of such a structure or component.

The controller 5 is configured to actuate a motor (not shown) to control the operations of the rollers 4, thereby conveying the recording medium 101. The controller 5 is further configured to drive the line heads 3 to eject ink toward the recording medium 101 during the conveyance of the recording medium 101.

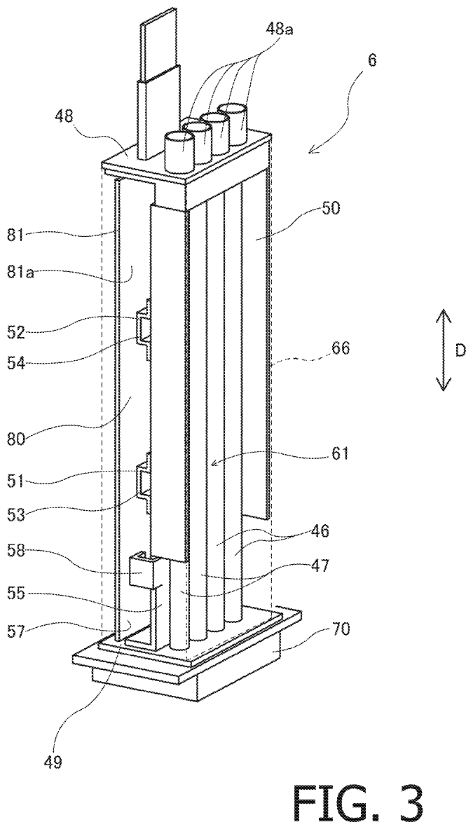

FIG. 2 is a plan view illustrating an example of a main part of one of the line heads 3 as viewed from a nozzle surface side. The line head 3 extends in a direction intersecting or perpendicular to the conveying direction of the recording medium 101. The line head 3 includes a unit support plate 30 having a rectangular shape in plan view, multiple head units 6 fitted into openings formed in the unit support plate 30 and supported thereby. That is, the unit support plate 30 serves to mount and support the multiple head units 6. In the example shown in FIG. 2, the line head 3 includes nine head units 6. However, the number of head units 6 is not limited to nine. As will be described in detail below, each head unit 6 includes an ejection head 70 (see FIG. 3) having a nozzle plate 71, on which multiple ejection openings of nozzles 78 are formed. As the multiple head units 6 are fitted into respective openings of the unit support plate 30, a surface of each nozzle plate 71 is exposed from the unit support plate 30, as shown in FIG. 2. The exposed surface of each nozzle plate 71 is referred to as the “nozzle surface”.

The head units 6 are arranged in two rows along the conveying direction of the recording medium 101. In one of the rows, four head units 6 are aligned along the direction in which the line head 3 extends, while in the other row, five head units 6 are aligned in the same manner. On the nozzle surface of each head unit 6, multiple ejection openings of nozzles 78 are formed. In FIG. 2, the ejection openings of the nozzles 78 are illustrated schematically and differ from their actual arrangement and quantity.

Each line head 3 includes a reservoir configured to store ink. The reservoir is connected to an ink cartridge. Ink is supplied from the ink cartridge to the reservoir, and the reservoir stores a required amount of ink. The reservoir is configured to supply the ink to the head units 6 of the line head 3 via tubes configured to supply liquid.

FIG. 3 is a perspective view illustrating an example of one of the head units 6 according to the present embodiment. The head unit 6 is detachably attached to a main body of the line head 3. Each head unit 6 includes the ejection head 70, an electronic circuit board 80, a cooling mechanism 61, a pair of ink flow tubes 46, and a pair of coolant flow tubes 47. The head unit 6 also includes a casing 66 (indicated by broken lines) that covers internal components. The ink flow tubes 46 are liquid flow tubes configured to supply a liquid, that is, ink, which is to be ejected from the nozzles 78. The ink flow tubes 46 are, for example, silicon tubes or rubber tubes. The ink flow tubes 46 and the coolant flow tubes 47 extend in an intersecting direction D which will be described later.

FIG. 4 is a cross-sectional view of a main part of the ejection head 70 according to the present embodiment. As shown in FIG. 4, the ejection head 70 includes the nozzle plate 71, an ink flow path member 72, a frame 73, a coolant flow path member 74, and a fixing frame 75. The nozzle plate 71, the ink flow path member 72, the frame 73, the coolant flow path member 74, and the fixing frame 75 are all plate-like members and are stacked in this order.

The ejection head 70 also includes internal ink flow paths 41 formed in the frame 73, the coolant flow path member 74, and the fixing frame 75. The internal ink flow paths 41 are configured to guide ink into the ink flow path member 72 and return the ink from the ink flow path member 72 to the reservoir. Each internal ink flow path 41 has one end that opens to form an opening on an outer surface of the fixing frame 75. Ink flow tubes 46 are connected to the respective openings formed on the fixing frame 75. The ink flow tubes 46 extend in the direction D that intersects the nozzle plate 71. This direction D is hereinafter referred to as the intersecting direction.

The fixing frame 75 is mounted on the unit support plate 30 and fixed thereto. The fixing frame 75 includes an insertion hole 75a.

The coolant flow path member 74 includes an internal coolant flow path 42 configured to circulate coolant. The coolant flow path member 74 also includes a protruding portion 74a that protrudes outward. The protruding portion 74a is inserted through an insertion hole 75a and is exposed on an outer surface of the ejection head 70. Both ends of the internal coolant flow path 42 open to form respective openings on the outer surface of the protruding portion 74a. Coolant flow tubes 47 are connected to the respective openings. The coolant flow tubes 47 extend in the intersecting direction D. The coolant flow path member 74 further includes a recessed portion 74b formed on a surface facing the frame 73.

The frame 73 includes a hole 73a that forms a continuous space with the recessed portion 74b of the coolant flow path member 74.

The ink flow path member 72 is configured by stacking a plurality of metal plates in the intersecting direction D. The ink flow path member 72 includes a plurality of pressure chambers 72a, each formed to be in fluid communication with a corresponding nozzle 78, and vibration plates 72b. Each pressure chamber 72a is connected to the internal ink flow path 41 and to a corresponding nozzle 78. The pressure chambers 72a are open inward. Each vibration plate 72b covers and closes the opening of the corresponding pressure chamber 72a.

The outer surface of the nozzle plate 71 constitutes the nozzle surface. Multiple nozzles 78 for ejecting ink are formed in the nozzle plate 71.

The ejection head 70 further includes head drive units 79, an actuator 76, and connectors 77.

The head drive units 79 are fixed to the recessed portion 74b of the coolant flow path member 74. Each of the head drive units 79 is, for example, an integrated circuit. The actuator 76 is fixed to a surface of the ink flow path member 72 that faces the frame 73. The actuator 76 includes a piezoelectric layer configured to cause ink to be ejected from the nozzles 78. The actuator 76 is positioned within the hole 73a of the frame 73. The connectors 77 electrically connect the actuator 76 to the head drive units 79. The connectors 77 are, for example, flexible sheets such as COF (Chip On Film).

Control signals from the controller 5 are input to the head drive units 79. The head drive units 79 generate drive signals based on the control signals and output the drive signals to the actuators 76 via the connectors 77. When the drive signals are input to the actuators 76, the piezoelectric layers are actuated to vibrate the vibration plates 72b, thereby ejecting ink from the ejection openings of the nozzles 78. In other words, the head drive units 79 drive the actuators 76 to eject liquid from the nozzles 78.

As the actuators 76 and the head drive units 79 operate, they generate heat, which causes an increase in the temperature of the ink flow path member 72 and surrounding components. In the present embodiment, the head drive units 79, the ink flow path member 72, and the actuators 76 are cooled by a coolant that flows through the coolant flow path member 74 via the pair of coolant flow tubes 47. The coolant is circulated by a pump provided in the liquid ejection device 100. The pump is located outside the head unit 6. The pump, the coolant flow tubes 47, and the internal coolant flow path 42 together constitute a cooling mechanism for cooling the ejection head 70.

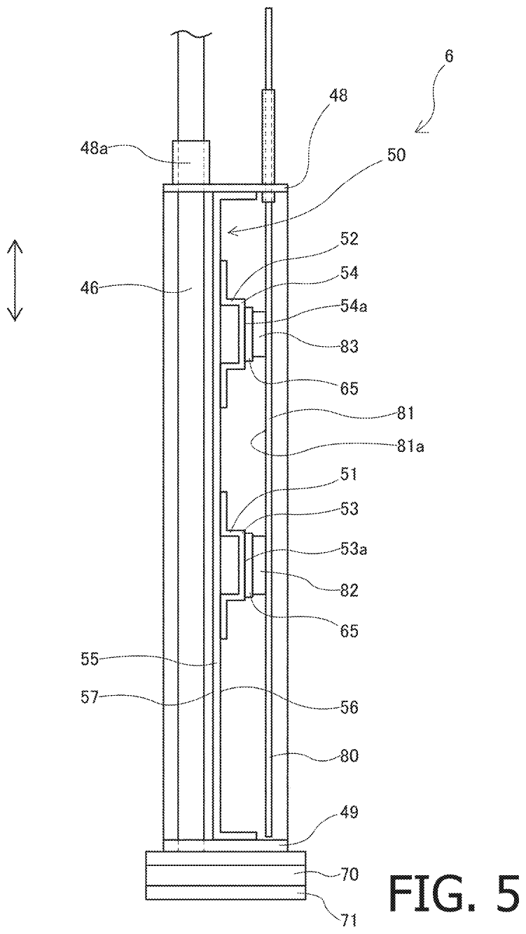

FIG. 5 is a side view illustrating an example of the head unit 6 according to the present embodiment. In FIG. 5, the coolant flow tubes 47 are omitted for clarity. The electronic circuit board 80 includes circuitry for controlling the head drive units 79. The electronic circuit board 80 includes a substrate 81 and one or more electronic components mounted on a substrate surface 81a of the substrate 81. The substrate 81 may be, for example, a printed circuit board. The substrate surface 81a extends in the intersecting direction D, which intersects or is perpendicular to the plane of the nozzle plate 71.

The electronic components are configured to control the head drive units 79 (see FIG. 4). These electronic components generate heat during the operation of the head drive units 79. The electronic circuit board 80 includes, as heat-generating components, a first electronic component 82 and a second electronic component 83. Each of the first and second electronic components 82 and 83 includes, for example, an integrated circuit such as the FPGA and an outer shell enclosing the integrated circuit. A top surface of the outer shell is typically flat. The first and second electronic components 82 and 83 have different sizes of installation areas. For example, the installation area of the second electronic component 83 is smaller than that of the first electronic component 82. Furthermore, the second electronic component 83 is positioned farther from the ejection head 70 than the first electronic component 82 in the intersecting direction D.

As shown in FIG. 3, the head unit 6 further includes a support structure configured to hold the coolant flow tubes 47. The support structure includes a top plate 48, a bottom plate 49, and a supporting body 50.

The top plate 48 is positioned on a plane that intersects or is perpendicular to the intersecting direction D. The top plate 48 includes four sockets 48a. The pair of ink flow tubes 46 and the pair of coolant flow tubes 47 are respectively connected to the four sockets 48a. Each of the sockets 48a is also connected to external piping. The external piping includes a tube for supplying ink to the head unit 6 and a tube for discharging ink from the head unit 6, which are in fluid communication with the pair of ink flow tubes 46, respectively, and a tube for supplying coolant to the head unit 6 and a tube for discharging coolant from the head unit 6, which are in fluid communication with the pair of coolant flow tubes 47, respectively.

The bottom plate 49 is positioned on a plane that intersects or is perpendicular to the intersecting direction D and extends substantially in parallel with the top plate 48 with a gap therebetween. The bottom plate 49 is fixed to the ejection head 70. The bottom plate 49 is made of a material having high thermal conductivity, such as metal.

The head unit 6 includes a supporting body 50 that extends in the intersecting direction D and connects the top plate 48 and the bottom plate 49. As shown in FIGS. 3, 5, and 6, the supporting body 50 has a shape that includes a rectangular plate portion (which will also be referred to as a supporting body main portion 55) positioned between the electronic circuit board 80 and a pair of ink flow tubes 46 and a pair of coolant flow tubes 47. Extending from both side edges of this rectangular plate portion in a direction perpendicular to the intersecting direction D are a pair of generally planar side portions, which are bent in a direction away from the electronic circuit board 80. At the lower ends of these side portions, substrate holding portions 58 are formed so as to extend toward the substrate 81. The substrate 81 is fixed to the respective substrate holding portions 58. The substrate holding portions 58 are connected to the bottom plate 49, and the upper ends of the planar side portions are bent and connected to the top plate 48. In this way, the top plate 48 and the bottom plate 49 are mechanically connected via the supporting body 50.

The supporting body 50 is made of a material having high thermal conductivity, such as metal. As shown in FIG. 5, the supporting body 50 includes the supporting body main portion 55, and a first contact plate 51 and a second contact plate 52 as contact parts. The supporting body main portion 55 and the contact plates 51 and 52 may be provided as separate components, or may be formed as an integral component.

The supporting body main portion 55 is a plate-like structure extending in the intersecting direction D, and includes a first surface 56 that faces the substrate surface 81a of the substrate 81, and a second surface 57 that is opposite to the first surface 56. The pair of ink flow tubes 46 and the pair of coolant flow tubes 47 pass through a space that is defined in part by the second surface 57. Accordingly, the supporting body main portion 55 is located between the electronic circuit board 80 and the ink flow tubes 46 and the coolant flow tubes 47.

The supporting body main portion 55 has its upper end (on the top plate 48 side) bent in a direction intersecting or perpendicular to the intersecting direction D, such that the bent portion comes into contact with and is fixed to the top plate 48. Similarly, the lower end (on the bottom plate 49 side) is also bent in a direction intersecting or perpendicular to the intersecting direction D, and is fixed to the bottom plate 49. These bent portions not only provide mechanical fixation but also ensure thermal contact with the top and bottom plates. In this manner, the supporting body 50 thermally contacts and physically supports the ejection head 70.

The supporting body 50 further includes contact plates that contact the electronic components 82 and 83. As used herein, “contact” includes both direct contact between the contact plates and the electronic components, and indirect contact through an interposed member having thermal conductivity.

In the present embodiment, the contact plates 51 and 52 are made of material having high thermal conductivity. The first contact plate 51 includes a first protruding portion 53, and the second contact plate 52 includes a second protruding portion 54.

The first contact plate 51 is formed as a plate-like body, of which an inner surface is in contact with the first surface 56 of the supporting body main portion 55 and is fixed thereto. A central part of the first contact plate 51 in the intersecting direction D is bent into a rectangular convex portion, thereby forming a first protruding portion 53. The first protruding portion 53 protrudes from the first surface 56 toward the first electronic component 82. An outer surface of the central part of the first protruding portion 53 is flat and defines a first contact portion 53a. The first contact portion 53a faces the first electronic component 82 and is in contact with the first electronic component 82 via a thermally conductive part 65. That is, the first contact portion 53a is the portion that contacts the thermally conductive part 65.

The second contact plate 52 is formed as a plate-like body, of which an inner surface is in contact with the first surface 56 of the supporting body main portion 55 and is fixed thereto. A central part of the second contact plate 52 in the intersecting direction D is bent into a rectangular convex portion, thereby forming a second protruding portion 54. The second protruding portion 54 protrudes from the first surface 56 toward the second electronic component 83. An outer surface of the central part of the second protruding portion 54 is flat and defines a second contact portion 54a. The second contact portion 54a faces the second electronic component 83 and is in contact with the second electronic component 83 via a thermally conductive part 65. That is, the second contact portion 54a is the portion that contacts the thermally conductive part 65.

The thermally conductive part 65 is interposed between the contact plates and the electronic components to establish thermal contact therebetween. In the present embodiment, multiple thermally conductive parts 65 are provided, and are respectively interposed between the first contact portion 53a and the first electronic component 82, and between the second contact portion 54a and the second electronic component 83. By interposing the thermally conductive part 65 between the contact plates and the electronic components, the formation of gaps therebetween can be prevented, thereby enhancing thermal conduction efficiency. The thermally conductive part 65 may be, for example, a thermally conductive flexible resin or paste containing carbon particles, or a liquid metal.

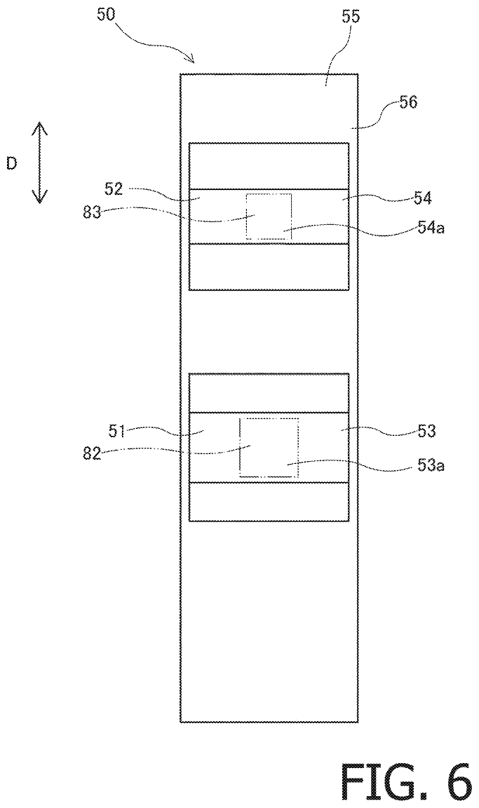

FIG. 6 is a side view illustrating an example of the head unit 6. Specifically, FIG. 6 shows the first surface 56 as viewed in the normal direction. As shown in FIG. 6, the area of the second contact portion 54a of the second electronic component 83 is smaller than that of the first contact portion 53a of the first electronic component 82.

The area sizes of the first contact plate 51 and the second contact plate 52 are greater than the areas of the top surfaces of the first and second electronic components 82 and 83, respectively. This increases the heat capacity on the side of the supporting body 50 and reduces thermal resistance.

As described above, the first and second electronic components 82 and 83 are in thermal contact with the ejection head 70, which is cooled by the cooling mechanism 61. When the head unit 6 is driven, the heat generated by the first and second electronic components 82 and 83 is conducted through the supporting body 50 and the ejection head 70 to the cooling mechanism 61, and then dissipated to the outside of the head unit 6. This configuration enables heat inside the head unit 6 to be discharged externally, thereby suppressing the heating of ink by the heat generated by the first and second electronic components 82 and 83. Consequently, the ink ejection operation of the ejection head 70 can be stabilized.

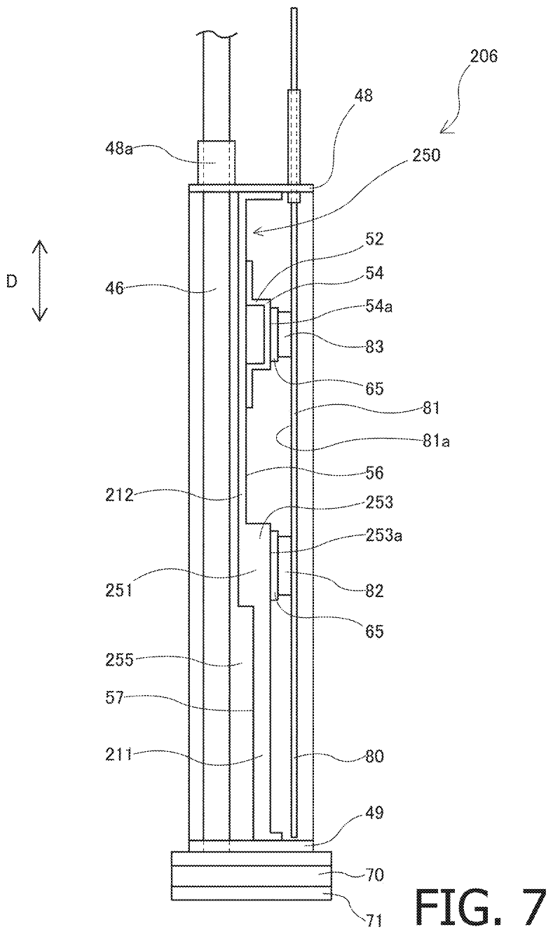

Hereinafter, a second embodiment of the present disclosure will be described, with a focus on differences from the first embodiment. FIG. 7 is a side view illustrating an example of a head unit 206 of a liquid ejection device according to the second embodiment. The basic configuration of the second embodiment is substantially the same as that of the first embodiment, except for the structure of a supporting body 250.

The supporting body 250 of the head unit 6 according to the second embodiment includes a first portion 211, a first contact plate 251, a second portion 212, and a second contact plate 52.

The first portion 211 is positioned adjacent to the first contact plate 251, has a certain thickness, extends in the intersecting direction D, and reaches the ejection head 70.

The first contact plate 251 is located farther from the ejection head 70 than the first portion 211 in the intersecting direction D. The first contact plate 251 is adjacent to and continuous with the first portion 211. A first rectangular convex portion 253 is formed integrally with the supporting body main portion 255. The first rectangular convex portion 253 is in contact with the first electronic component 82 via the thermally conductive part 65.

The second portion 212 is a portion different from the first portion 211, and is located farther from the ejection head 70 than the first contact plate 251 in the intersecting direction D. The second portion 212 is adjacent to and continuous with the first contact plate 251, and has a certain thickness and extends in the intersecting direction D. The first portion 211 is thicker than the second portion 212. With this configuration, the heat resistance in the portion through which heat travels from a second electronic component contact portion 17 toward the ejection head 70, in addition to the heat traveling from a first electronic component contact portion 16 toward the ejection head 70, can be reduced.

The second contact plate 52 is fixed to the first surface 56 of the second portion 212. In the first rectangular convex portion 253 of the first contact plate 251, the first contact portion 253a, which is the portion that contacts the first electronic component 82 via the thermally conductive part 65, has a greater thickness than the second contact portion 54a of the second contact plate 52. With this configuration, the heat resistance of the first contact portion 253a, which serves as a path for heat traveling from the second electronic component contact portion 17 toward the ejection head 70 as well as from the first electronic component contact portion 16, can be reduced.

As described above, since the first portion 211, which is located closer to the ejection head 70 of the supporting body 250 than the second portion 212, has a greater thickness than the second portion 212, which is located farther from the ejection head 70, the heat resistance of the supporting body 250 can be reduced. Therefore, the heat generated by the electronic components 82 and 83 can be efficiently dissipated to the cooling mechanism 61 via the supporting body 250 and the ejection head 70.

Furthermore, the distance between the first portion 211 and the ink flow tube 46 is greater than the distance between the second portion 212 and the ink flow tube 46. This configuration helps suppress heating of the ink flowing through a portion of the ink flow tube 46 near the ejection head 70 due to heat generated by the supporting body 250. As a result, the ink ejection operation of the ejection head 70 can be further stabilized.

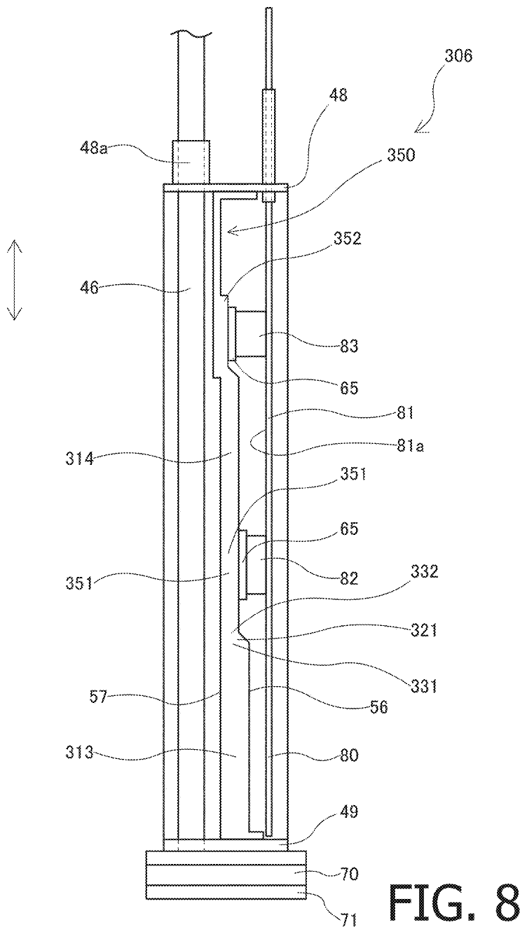

Hereinafter, a third embodiment will be described, focusing mainly on differences from the first embodiment. FIG. 8 is a side view illustrating an example of a head unit 306 of the liquid ejection device according to the third embodiment. The basic configuration of the third embodiment is the same as that of the first embodiment, except for the configuration of the supporting body.

The supporting body 350 of the head unit 306 according to the third embodiment includes a third portion 313, a fourth portion 314, a first connecting portion 321, a first contact plate 351, and a second contact plate 352.

The third portion 313 has a certain thickness, extends in the intersecting direction D, and reaches the ejection head 70.

The fourth portion 314 is located farther from the ejection head 70 than the third portion 313 in the intersecting direction D. The fourth portion 314 has a certain thickness and extends in the intersecting direction D. The third portion 313 is thicker than the fourth portion 314.

The first connecting portion 321 connects the third portion 313 and the fourth portion 314, which differ in thickness. The first connecting portion 321 has a shape in which the thickness gradually increases toward the ejection head 70. That is, the first connecting portion 321 includes a first position 331 located between the first electronic component 82 and the ejection head 70, and a second position 332 located between the first position 331 and the first electronic component 82. The thickness of the first connecting portion 321 at the first position 331 is greater than that at the second position 332. With this configuration, the thermal resistance of the supporting body 350 can be reduced, and the heat generated by the electronic component can be efficiently dissipated from the supporting body 350 to the cooling mechanism 61 via the ejection head 70.

The first contact plate 351 is provided on the fourth portion 314 and contacts the first electronic component 82 via the thermally conductive part 65. The second contact plate 352 is provided at a position farther from the ejection head 70 than the fourth portion 314 in the intersecting direction D, and contacts the second electronic component 83 via the thermally conductive part 65.

In the above-described embodiments, thermal transfer from the electronic components (82, 83) to the cooling mechanism (61) is realized through a structural pathway configured to facilitate the movement of heat. Specifically, the supporting body (50, 250, 350) serves as a heat transfer path that thermally couples the electronic components (82, 83) to the ejection head (70), which is itself thermally coupled to the cooling mechanism (61). This thermal coupling is not merely incidental but is achieved by intentional configuration of the components, including the layout, dimensions, and material selection of the structural elements involved.

Each of the contact plates (51, 52, 251, 351, 352) is formed from a thermally conductive material, such as metal, and includes protruding convex portions (53, 54, 253) configured to face the respective electronic components (82, 83). These convex portions have planar outer surfaces (53a, 54a, 253a) that thermally contact the electronic components via thermally conductive parts (65), such as thermally conductive paste or flexible resin.

The contact plates are fixed to a support body main portion (55, 255) or to portions (211, 212, 313, 314) that extend in the intersecting direction (D) toward the ejection head (70). The support body portions are also made from high thermal conductivity materials and are fixed to the ejection head (70) via bottom plates (49), thereby forming a continuous thermal path.

The first portions (211, 313) located closer to the ejection head (70) are intentionally made thicker than the second portions (212, 314) located farther from the ejection head (70). This difference in thickness serves to reduce the thermal resistance along the path from the contact points with the electronic components to the ejection head (70). Additionally, the connection portions (321) connecting regions of different thickness are formed with gradually changing thickness, further ensuring efficient thermal conduction.

The thermal transfer path, therefore, includes: (i) contact surfaces (53a, 54a, 253a) of the contact plates (51, 52, 251, 352); (ii) thermally conductive parts (65); (iii) thermally conductive portions of the support body (50, 250, 350); (iv) the ejection head (70); and (v) the cooling mechanism (61). This arrangement creates a directional heat flow from the electronic components to the cooling mechanism.

Moreover, by arranging the liquid flow path tubes (46) on the side opposite to the supporting body's first surface (56), and by increasing the spacing between the liquid flow path tube and the thicker first portion (211, 313), the configuration reduces the likelihood that the heat emitted from the support body will raise the temperature of the ink. This contributes to stabilizing the ink ejection operation by preventing ink temperature fluctuations caused by thermal influence from the electronic components.

This structural heat-transfer configuration thus actively contributes to the cooling of the electronic components, not merely by thermal coupling but by forming a purposeful, directionally configured thermal pathway that efficiently transfers heat away from the electronic components to the cooling mechanism.

While the present disclosure has been described in conjunction with the three embodiments above, it is to be understood that many modifications, variations, improvements, and other embodiments will become apparent to those skilled in the art based on the foregoing description. Therefore, the above description is provided only by way of example to teach the best mode for carrying out aspects of the present disclosure, and is not intended to limit the scope thereof. Various changes in structure and/or function may be made without departing from the spirit and scope of the present disclosure. Accordingly, the present disclosure is intended to embrace all known or later developed alternatives, modifications, variations, improvements, and substantial equivalents.

What is claimed is

1. A liquid ejection device comprising:
an ejection head including a nozzle plate having a plurality of nozzles, a plurality of actuators, and a head drive unit configured to drive the plurality of actuators to eject the liquid from the plurality of nozzles;
a substrate having a substrate surface extending in a direction intersecting the nozzle plate;
one or more electronic components mounted on a substrate surface, the electronic components being configured to control the head drive unit;
a cooling mechanism configured to cool the ejection head; and
a supporting body configure to support the ejection head,
wherein the supporting head thermally contacts the ejection head,
wherein the supporting body includes a first surface, the first surface facing the substrate surface, the first surface extending in the intersecting direction, and
wherein one or more contact parts thermally contact the one or more electronic components.

2. The liquid ejection device according to claim 1,
wherein the one or more electronic components include a first electronic component and a second electronic component.

3. The liquid ejection device according to claim 1,
wherein each of the one or more contact parts includes a protruding portion that protrudes from the first surface toward the electronic components.

4. The liquid ejection device according to claim 2,
wherein the one or more contact parts include:
a first protruding portion that protrudes from the first surface toward the first electronic component and is in thermal contact with the first electronic component; and
a second protruding portion protruding from the first surface toward the second electronic component, the protrude portion being in thermal contact with the second electronic component.

5. The liquid ejection device according to claim 4,
wherein an area size of a first contact portion is greater than an area size of a second contact portion, the first contact portion being a part of the first protruding portion configured to contact the first electronic component, the second contact portion being a part of the second protruding portion configured to contact the second electronic component.

6. The liquid ejection device according to claim 5, wherein the first contact portion has greater thickness than the second contact portion.

7. The liquid ejection device according to claim 1,
further comprising a thermally conductive part interposed between the one or more contact parts and the electronic components to establish thermal contact therebetween.

8. The liquid ejection device according to claim 1,
wherein the electronic components have top surfaces, and
wherein an area size of the one or more contact parts is greater than an area size of the top surfaces of the electronic components.

9. The liquid ejection device according to claim 1,
wherein the supporting body includes a first portion, the one or more contact parts located farther from the ejection head than the first portion in the intersecting direction, and a second portion located farther from the ejection head than the one or more contact parts in the intersecting direction,
wherein the first portion is adjacent to the one or more contact parts,
wherein the first portion has a first thickness, the first portion extending in the intersecting direction,
wherein the second portion is adjacent to the one or more contact parts,
wherein the second portion has a second thickness, the second portion extending in the intersecting direction, and
wherein the first portion is thicker than the second portion.

10. The liquid ejection device according to claim 1,
further comprising a liquid flow path tube for supplying the liquid to be ejected through the nozzles from the ejection head, the liquid flow path tube passing through a space defined in part by a second surface of the supporting body, the second surface being opposite to the first surface,
wherein the supporting body includes:
a first portion;
one or more contact parts located farther from the ejection head than the first portion in the intersecting direction; and
a second portion located farther from the ejection head than the one or more contact parts in the intersecting direction,
wherein the first portion is adjacent to the one or more contact parts, the first portion extending in the intersecting direction,
wherein the second portion is different from the first portion, is adjacent to the one or more contact parts, the second portion extending in the intersecting direction, and
wherein a distance between the first portion and the liquid flow path tube is greater than a distance between the second portion and the liquid flow path tube.

11. The liquid ejection device according to claim 1,
wherein the supporting body includes:
a third portion having a third thickness, the third portion extending in the intersecting direction;
a fourth portion having a fourth thickness different from the third thickness, the fourth portion extending in the intersecting direction; and
a connecting portion connecting the third portion and the fourth portion.

12. The liquid ejection device according to claim 11,
wherein the connecting portion includes a first position located between the electronic components and the ejection head, and a second position located between the first position and the electronic components, and
wherein a thickness of the connecting portion at the first position is greater than a thickness of the connecting portion at the second position.

13. A liquid ejection device comprising:
an ejection head including a nozzle plate having a plurality of nozzles configured to eject liquid, an actuator, and a head drive unit configured to drive the actuator to eject the liquid from the nozzles;
a substrate having a substrate surface extending in a direction intersecting the nozzle plate;
one or more electronic components disposed on the substrate surface, the electronic components being configured to control the head drive unit;
a cooling mechanism configured to cool the ejection head; and
a thermal coupling and heat-transfer structure configured to transfer heat generated by the electronic components to the ejection head, which is cooled by the cooling mechanism.
